(19) United States
(12) Patent Application Publication
(10) Pub. No.: US 2026/0194942 A1
(43) Pub. Date: Jul. 9, 2026

(54) THERMAL CONTROL STRATEGY USING A RECURRENT NEURAL NETWORK

(71) Applicant: Dell Products L.P., Round Rock, TX (US)

(72) Inventor: Yayun Liu, Austin, TX (US)

(21) Appl. No.: 19/015,124

(22) Filed: Jan. 9, 2025

(51) Int. Cl. G06F 1/20; G05B 13/02; G05B 13/04

(52) U.S. Cl. CPC G06F 1/20; G05B 13/027; G05B 13/048

(57) ABSTRACT

A method for deploying a thermal prediction model includes making a first determination, by a controller, that a target hardware component's thermal data is unavailable. In addition, the method includes sending, in response to the first determination, a request to the thermal prediction model for a predicted thermal state of the target hardware component. Moreover, the method includes receiving, from the thermal prediction model, the predicted thermal state of the target hardware component. Further, the method includes adjusting, using the controller and based on the predicted thermal state, thermal regulation of the target hardware component.

### BACKGROUND

Hardware components in computing systems often generate heat during operation, making efficient thermal regulation necessary to ensure optimal performance and reliability of the computing systems. Thermal sensors are commonly employed to measure the thermal properties of the hardware components such as temperature and heat dissipation. However, these sensors often fail for many reasons.

### BRIEF DESCRIPTION OF DRAWINGS

Certain embodiments of the disclosure will now be described with reference to the accompanying drawings. However, the accompanying drawings illustrate only certain aspects or implementations of the disclosure by way of example and are not meant to limit the scope of the claims.

FIG. 1 shows a system in accordance with one or more embodiments.

FIG. 2 shows a flowchart of a method for deploying a thermal prediction model in accordance with one or more embodiments.

FIG. 3 shows a flowchart of a method for generating a thermal prediction model in accordance with one or more embodiments.

FIG. 4 shows a diagram of a computing device in accordance with one or more embodiments.

### DETAILED DESCRIPTION

Modern computing systems are composed of multiple hardware components critical to the computing systems' overall functionality. These hardware components, such as processors, memory, and graphic processing units (GPUs), generate significant amounts of heat during operation. Excessive heating of the hardware components can lead to decreased performance, reduced efficiency, and even long-term damage to the hardware components and the computing system as a whole. Consequently, effective cooling systems are necessary for maintaining optimal and reliable operation. Traditional cooling systems operate on closed-loop or open-loop systems. A closed-loop cooling system relies on real-time feedback from thermal sensors to dynamically adjust cooling devices (e.g., air coolers (e.g., fans), liquid coolers, passive coolers (e.g., heat sinks), thermoelectric coolers, etc.) based on the actual temperature of hardware components. In contrast, open-loop cooling systems use preset configurations or thermal tiers to control the cooling devices without real-time feedback. Typically, closed-loop cooling systems operate using data collected from thermal sensors positioned throughout the computing system. In some cases, individual thermal sensors are mounted directly on each of the hardware components to provide precise readings for each hardware component. The thermal sensor data enables the closed-loop cooling system to identify and execute appropriate cooling actions using the cooling devices (e.g., increasing fan speed, decreasing fan speed, etc.). However, the reliability of closed-loop cooling systems is heavily dependent on the accuracy of the thermal sensors. If a thermal sensor malfunctions or fails, the closed-loop cooling system may lose its ability to monitor temperature effectively leading to potential overheating or ineffective cooling strategies. Thermal sensor failures can occur due to various reasons including but not limited to hardware degradation, environmental factors, or manufacturing defects.

In light of these challenges, there is a need for closed-loop cooling systems that can detect or predict temperature conditions without accurate thermal sensor data. This disclosure introduces a closed-loop cooling system that uses a recurrent neural network (RNN) to predict the thermal state of a target hardware component using the thermal data from hardware components of the same computing system when the target hardware component's thermal data is unavailable allowing the system to employ appropriate cooling measures.

Specific embodiments will now be described with reference to the accompanying figures.

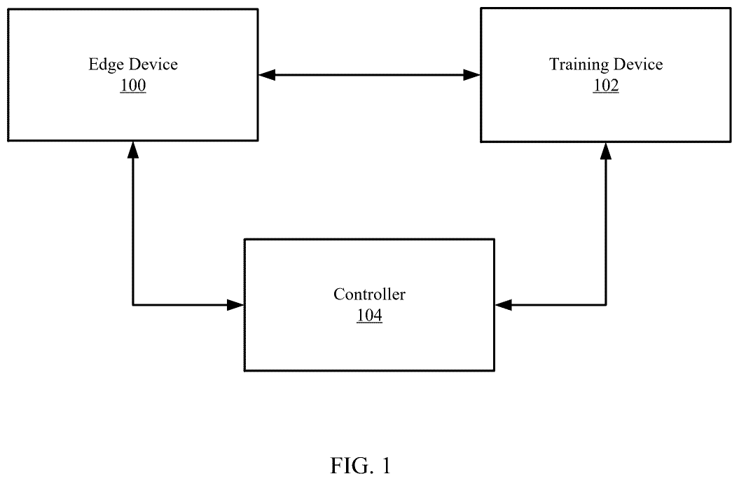

FIG. 1 shows a system in accordance with one or more embodiments. The system may include an edge device (100), a training device (102), and a controller (104). The system may include additional, fewer, and/or different components without departing from the scope of the embodiments disclosed herein. Each component may be operably/operatively connected to any of the other components via any combination of wired and/or wireless connections. Each of these system components is described below.

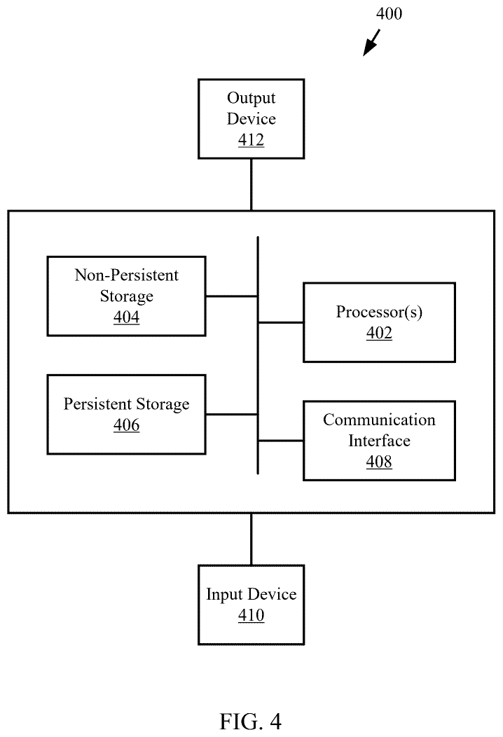

In one or more embodiments, the edge device (100) may be a physical device such as a computing system (e.g., a laptop, a cell phone, a tablet computer, a server, etc.) configured for hosting one or more workloads, or for providing a computing environment whereon workloads may be implemented. For example, the edge device (100) may be a computing system (e.g., 400, FIG. 4) as discussed below in more detail in FIG. 4. In one or more embodiments, the edge device (100) may include a set of hardware components including but not limited to, computing components (e.g., processors, GPUs, application specific integrated circuits (ASIC), etc.), storage components (e.g., solid state drives (SSDs), random access memory (RAM), etc.), and communication components (Wi-Fi modules, modems, peripheral components, etc.). In one or more embodiments, the edge device (100) may include cooling devices (not shown). In one or more embodiments, cooling devices include but should not be limited to, air coolers (e.g., fans), liquid coolers, passive coolers (e.g., heat sinks), thermoelectric coolers, or a combination thereof. In one or more embodiments, the hardware components heat up as the edge device (100) is used. In one or more embodiments, the edge device (100) includes thermal sensors (not shown) used to monitor the temperature of the hardware components. In one or more embodiments, each hardware component may have a dedicated thermal sensor. In one more embodiments. the thermal sensors produce thermal data (i.e., temperature data about the hardware components). In one or more embodiments, each of the thermal sensors may be dedicated to only one hardware component or multiple hardware components. In one or more embodiments, the cooling devices communicate with the thermal sensors to regulate the heat of the hardware components. In one or more embodiments. the edge device (100) may include a user interface (e.g., a graphical user interface) (not shown) that allows a user to interact with the edge device (100).

In one or more embodiments, the edge device (100) may include any number of applications (and/or content accessible through the applications) that provide computer-implemented services to a user. Applications may be designed and configured to perform one or more functions instantiated by a user of the edge device (100). In order to provide application services, each application may host similar or different components. The components may be, for example (but not limited to), instances of databases, instances of email servers, etc. Applications may be executed on one or more edge device(s) (100) as instances of the application.

Applications may vary in different embodiments, but in certain embodiments, applications may be custom developed or commercial (e.g., off-the-shelf) applications that a user desires to execute on the edge device (100). In one or more embodiments, applications may be logical entities executed using computing resources of the edge device (100). For example, applications may be implemented as computer instructions stored on persistent storage of the edge device (100) that when executed by the processor(s) of the edge device (100), cause the edge device (100) to provide the functionality of the applications described throughout the application.

In one or more embodiments, while performing, for example, one or more operations requested by a user, applications installed on the edge device (100) may include functionality to request and use physical and logical resources of the edge device (100). Applications may also include functionality to use data stored in storage/memory resources of the edge device (100). The applications may perform other types of functionalities not listed above without departing from the scope of the embodiments disclosed herein. While providing application services to a user, applications may store data that may be relevant to the user in storage/memory resources of the edge device (100).

In one or more embodiments, to provide services to the users, the edge device (100) may utilize, rely on, or otherwise cooperate with an infrastructure node (IN) (not shown). For example, the edge devices (100) may issue requests to the IN to receive responses and interact with various components of the IN. The edge device (100) may also request data from and/or send data to the IN (for example, the edge devices (100) may transmit information to the IN that allows the IN to perform computations, the results of which are used by the edge device (100) to provide services to the users). As yet another example, the edge device (100) may utilize computer-implemented services provided by the IN. When the edge devices (100) interact with the IN, data that is relevant to the edge device (100) may be stored (temporarily or permanently) in the IN.

In one or more embodiments, the edge device (100) may be capable of, for example,: (i) collecting users' inputs, (ii) correlating collected users' inputs to the computer-implemented services to be provided to the users, (iii) communicating with IN that perform computations necessary to provide the computer-implemented services, (iv) using the computations performed by the infrastructure nodes to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the edge devices (100) may provide computer-implemented services to users (and/or other computing devices). The edge devices (100) may provide any number and any type of computer-implemented services. To provide computer-implemented services, an edge device (100) may include a collection of physical components (e.g., processing resources, storage/memory resources, networking resources, etc.) configured to perform operations of the edge device (100) and/or otherwise execute a collection of logical components (e.g., virtualization resources) of the edge device (100).

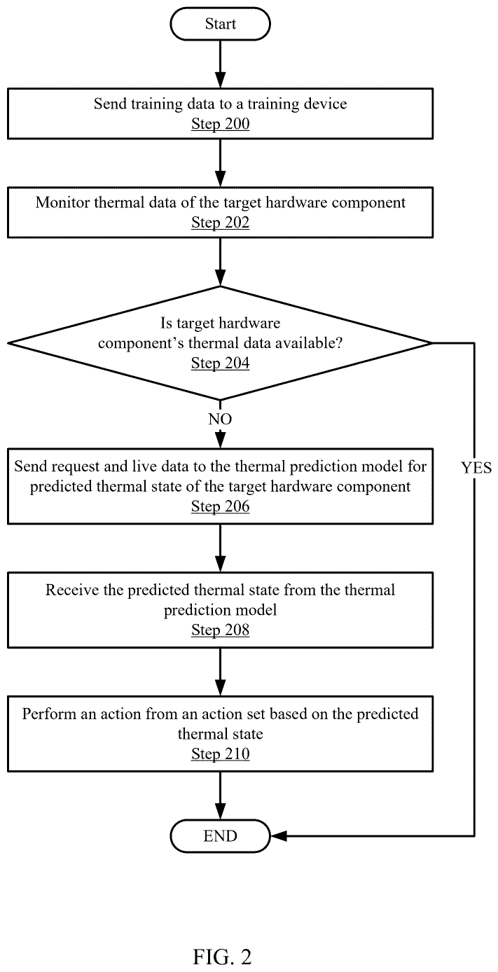

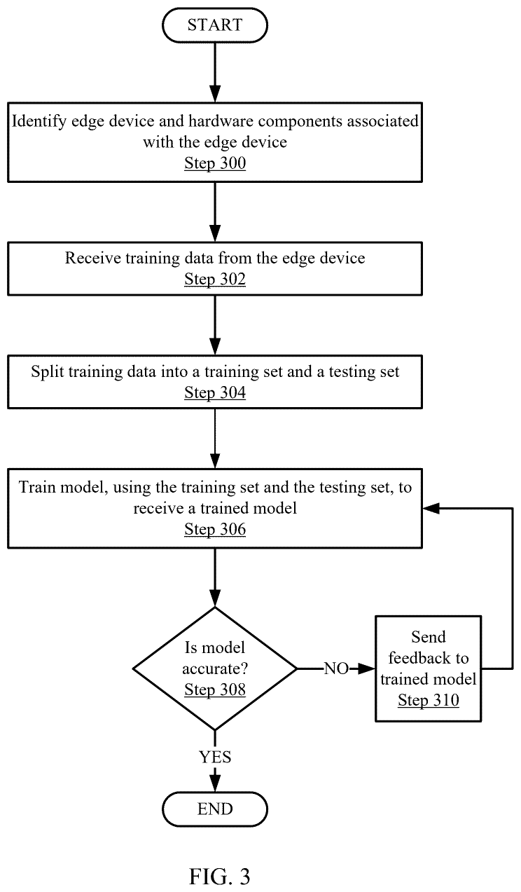

Further, the edge device (100) may include functionality to perform at least a portion of the methods shown in FIGS. 2-3. One of ordinary skill in the art will appreciate that the edge device (100) may perform other functionalities without departing from the scope of the embodiment disclosed herein.

In one or more embodiments, the edge device (100), the training device (102), and the controller (104) may be operatively connected to one another through the network (not shown) (e.g., a local area network (LAN), a wide area network (WAN) such as the Internet, a mobile network, any other network type, or a combination thereof). The network may be implemented using any combination of wired and/or wireless connections. Further, the network (not shown) may encompass various interconnected, network-enabled subcomponents (or systems) (e.g., switches, routers, gateways, etc.) that may facilitate communications between the edge device (100), the training device (102), and the controller (104). Moreover, the edge device (100), the training device (102), and the controller (104) may communicate with one another using any combination of wired and/or wireless communication protocols.

In one or more embodiments, the training device (102) includes the functionality to train a thermal prediction model. In one or more embodiments, the thermal prediction model may refer to a learning model with the functionality to predict the thermal state (i.e., temperature, heating/cooling rate, etc.) of a hardware component that does not have accurate thermal data using thermal data from other hardware components of the same edge device (100). In one or more embodiments, at least one thermal sensor dedicated monitoring hardware components may stop producing thermal data for various reasons including but not limited to, thermal sensor failure, a thermal sensor update, etc. In one or more embodiments, the thermal state of the hardware components may be influenced by other hardware components in the edge device (100). For example, a number of factors may influence the thermal state of hardware components including but not limited to, placement of the cooling devices, inlet temperature at one more inlets of the edge device (100), the edge device's (100) exhaust temperature, the relative location of the hardware component and other hardware components, and the temperature of other hardware components.

In one or more embodiments, the training device (102) may use a recurrent neural network (RNN) using long short-term memory (LSTM) functionality to make temperature predictions. In one or more embodiments, an RNN is a neural network (i.e., a system that learns patterns from training data by utilizing a number of layers, neurons, weights, biases, activation functions, propagation function, etc., which are generally used to model how the human brain processes information) designed to process sequential data by maintaining a memory of previous inputs. In one or more embodiments, LSTM refers to a specialized RNN that uses gates (i.e., decision-makers) to remember important data and forget unimportant data. Further, the training device (102) may include functionality to perform at least a portion of the methods shown in FIGS. 2-3. One of ordinary skill in the art will appreciate that the training device (102) may perform other functionalities without departing from the scope of the embodiment disclosed herein.

In one or more embodiments, the controller (104) includes the functionality to manage the hardware components of the edge device (100) and cooling devices of the edge device (100) to ensure thermal regulation of the hardware components. In one or more embodiments, the controller (104) includes the functionality to receive input from one or more of the thermal sensors. In one or more embodiments, when one or more hardware components pass a heat threshold, the controller (104) is configured to employ the cooling devices to cool one or more hardware components. In one or more embodiments, the heat threshold may be determined by any means known in the art or discovered in the future. The controller (104) may be implemented within the edge device (100) or be located remotely from the edge device (100). In one or more embodiments, the controller (104) utilizes a model trained by the training device (102) to determine and then execute a cooling operation for the edge device (100) by sending instructions to components of the edge device (100) or directly instructing components of the edge device (100). Further, the controller (104) may include functionality to perform at least a portion of the methods shown in FIGS. 2-3. One of ordinary skill in the art will appreciate that the controller (104) may perform other functionalities without departing from the scope of the embodiment disclosed herein.

In one or more embodiments, the edge device (100), the training device (102), and the controller (104) are each implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device cause the computing device to perform the functionality of the edge device (100), the training device (102), and the controller (104) described throughout this application.

In one or more embodiments, the edge device (100), the training device (102), and the controller (104) are each implemented as a logical device. The logical device may utilize the computing resources of any number of computing devices and thereby provide the functionality of the edge device (100), the training device (102), and the controller (104).

Turning to FIG. 2, FIG. 2 shows a flowchart of a method for deploying a thermal prediction model in accordance with one or more embodiments disclosed herein. The method may be performed by, for example, an edge device (e.g., 100 in FIG. 1). Other components in the system may perform this method without departing from the scope of the disclosure.

In step 200, the edge device (e.g., 100 in FIG. 1) sends training data to a training device (e.g., 102 in FIG. 1). In one or more embodiments, the training data may refer to data collected from hardware components of the edge device (e.g., 100 in FIG. 1) that includes temperature readings and thermal patterns under various operation conditions of the edge device (100 in FIG. 1). In one or more embodiments, the training data may be collected using thermal sensors of the edge device (e.g., 100 in FIG. 1). In one or more embodiments, the hardware components have one or more dedicated thermal sensors and/or the edge device (100 in FIG. 1) has one or more thermal sensors not associated with any particular hardware component (e.g., sensors at inlets and outlets, external sensors, etc.).

In one or more embodiments, any type of thermal sensors known in the art or discovered in the future may be used including but not limited to thermocouples, thermistors, diode-based sensors, etc. In one or more embodiments, the training data may be collected from the hardware components by any means known in the art or discovered in the future. In one or more embodiments, hardware components may include but not be limited to computing components (e.g., processors, GPUs, ASIC, etc.), storage components (e.g., SSDs, RAM, etc.), and communication components (Wi-Fi modules, modems, peripheral components, etc.) of the edge device (e.g., 100 in FIG. 1). In one or more embodiments, the training data may be used to train a model (e.g., a thermal prediction model) as described below in FIG. 3. In one or more embodiments, a model may refer to an algorithm trained on data to identify patterns, make predictions, or perform tasks based on an input. In one or more embodiments, the training data may include relationships between the thermal state (i.e., temperature, heating/cooling rate, etc.) of a target hardware component (i.e., a hardware component whose thermal state the thermal prediction model aims to predict) and the thermal state of other hardware components of the edge device (e.g., 100 in FIG. 1) as discussed below in FIG. 3. In one or more embodiments, the training data may be sent to the training device (e.g., 102 in FIG. 1) by any means known in the art or discovered in the future.

In step 202, the edge device (e.g., 100 in FIG. 1) monitors the thermal data of the target hardware component. In one or more embodiments, monitoring refers to determining whether the edge device (e.g., 100 in FIG. 1) is receiving any thermal data from the target hardware component's thermal sensor. In one or more embodiments, monitoring also refers to determining whether the edge device (e.g., 100 in FIG. 1) is receiving accurate thermal data. In one or more embodiments, the accuracy of the thermal data is determined by comparing past thermal data to the current thermal data. In one or more embodiments, the edge device (e.g., 100 in FIG. 1) monitors the thermal data of the target hardware component by any means known in the art discovered in the future. In one or more embodiments, the thermal sensor may be shared by multiple hardware components. In one or more embodiments, each of the hardware components may have more than one thermal sensor. In one or more embodiments, if the target hardware component has more than one temperature sensor, then the edge device (e.g., 100 in FIG. 1) may monitor the more than one thermal sensors of the target hardware component.

In step 204, the edge device (100 in FIG. 1) determines whether the target hardware component's thermal data is available (i.e., whether the target hardware component's thermal sensor(s) is sending thermal data to the edge device (e.g., 100 in FIG. 1)). In one or more embodiments, the unavailability of the thermal data may indicate that the target hardware component's thermal sensor is not operating correctly (i.e., is providing inaccurate data) or has failed. In one or more embodiments, the edge device (e.g., 100 in FIG. 1) may make this determination by any means known in the art or discovered in the future. In one or more embodiments, if the edge device (e.g., 100 in FIG. 1) determines that the target hardware component's thermal data is not available, the edge device (e.g., 100 in FIG. 1) may notify a user via a graphical user interface (GUI). Accordingly, if the result is YES then the method ends if the result is NO then the method proceeds to step 206.

In step 206, the edge device (e.g., 100 in FIG. 1) sends a request to the thermal prediction model to provide a predicted thermal state of the target hardware component. In one or more embodiments, in addition to sending the request the edge device (e.g., 100 in FIG. 1) may also send live thermal data of the hardware components to the thermal prediction model. It should be appreciated that the thermal prediction model may use live thermal data to predict the thermal state of the target hardware component. In one or more embodiments, the thermal prediction model is a model with the functionality to predict the thermal state of the target hardware component using the thermal data from other hardware components of the same edge device (e.g., 100 in FIG. 1), when the target hardware component's thermal data is unavailable. In one or more embodiments, the edge device (e.g., 100 in FIG. 1) may send the request to the thermal prediction model by any means known in the art or discovered in the future. In one or more embodiments, the request may be sent to a cloud device (not shown) to which the thermal prediction model is residing. Further, in one or more embodiments, the thermal prediction model is hosted by a controller (e.g., 104 in FIG. 1).

In step 208, the controller (e.g., 104 in FIG. 1) receives the predicted thermal state of the target hardware component from the thermal prediction model. In one or more embodiments, the predicted thermal state includes the predicted temperature of the target hardware component (e.g., the target hardware component is about 90° F. or 32° C.) at a current time and/or at a future time. In one or more embodiments, future thermal predictions are based on a confidence score of the thermal prediction model (e.g., the predicted thermal state will include future predictions until the future predictions are associated with a confidence score below a threshold level). In one or more embodiments, the predicted thermal states include a range of temperatures (e.g., the thermal prediction model may be highly confident in a temperature prediction and provide a small temperature range such as 0.1 degrees or be less confident in a temperature prediction and provide a larger temperature range such as 10 degrees). In one or more embodiments, the predicted thermal state may also include a prediction as to whether the temperature of the target hardware component's temperature is rising or falling and at what rate the temperature is rising or falling.

In step 210, the controller (e.g., 104 in FIG. 1) instructs the edge device (e.g., 100 in FIG. 1) and/or a hardware component of an edge device (e.g., 100 in FIG. 1) to perform an action from an action set based on the predicted thermal state of the target hardware component to adjust thermal regulation of the target hardware component (i.e., maintaining the target hardware component's temperature within a desired range). In one or more embodiments, the edge device (e.g., 100 in FIG. 1) includes more than one target hardware component. In one or more embodiments, the action from an action set adjusts the thermal regulation of the more than one target hardware components. In one or more embodiments, the actions in the action set may include but should not be limited to not changing, increasing, or decreasing the thermal regulation of one or more cooling devices of the edge device (e.g., 100 in FIG. 1), which includes adjusting fan speeds of fans, adjusting flow rates of liquid cooling, activating or deactivating cooling devices, adjusting flow paths of cooling circuits, adjusting the directions of cooling and/or exhaust paths, adjusting humidity control devices, etc. In one or more embodiments, cooling devices include but should not be limited to air coolers (e.g., fans), liquid coolers, passive coolers (e.g., heat sinks), thermoelectric coolers, humidity control devices (e.g., dehumidifiers, air conditioners, etc.), air direction devices (e.g., louvers), or a combination thereof. In one or more embodiments, steps 204-210 may repeat until the target hardware component's thermal data is available.

In one or more embodiments, the method may end following step 210.

Turning to FIG. 3, FIG. 3 shows a flowchart of a method for generating a thermal prediction model in accordance with one or more embodiments disclosed herein. The method may be performed by, for example, a training device (e.g., 102 in FIG. 1). Other components in the system may perform this method without departing from the scope of the disclosure.

In step 300, the training device (e.g., 102 in FIG. 1) identifies the edge device (e.g., 100 in FIG. 1) and the hardware components associated with the edge device (e.g., 100 in FIG. 1). In one or more embodiments, hardware components may include but not be limited to computing components (e.g., processors, GPUs, ASIC, etc.), storage components (e.g., SSDs, RAM, etc.), and communication components (Wi-Fi modules, modems, peripheral components, etc.) of the edge device (e.g., 100 in FIG. 1). In one or more embodiments, the training device (e.g., 102 in FIG. 1) may identify the edge device (e.g., 100 in FIG. 1) and the hardware components of the edge device (e.g., 100 in FIG. 1) by any means known in the art or discovered in the future.

In step 302, the training device (e.g., 102 in FIG. 1) receives training data from the edge device (e.g., 100 in FIG. 1). In one or more embodiments, the training data may refer to data collected from hardware components of the edge device (e.g., 100 in FIG. 1) that includes temperature readings and thermal patterns under various operation conditions of the edge device (100 in FIG. 1). In one or more embodiments, the training data is captured using thermal sensors of the edge device (e.g., 100 in FIG. 1). In one or more embodiments, each of the hardware components has a dedicated thermal sensor. In one or more embodiments, any type of thermal sensor known in the art or discovered in the future may be used including but not limited to thermocouples, thermistors, diode-based sensors, etc. In a non-limiting example, if the edge device (e.g., 100 in FIG. 1) is often used for video editing, then the system may simulate similar conditions and take readings of the hardware components' thermal data under such conditions to generate the training data. In one or more embodiments, the training data may be collected from the hardware components by any means known in the art or discovered in the future.

In one or more embodiments, the training data may be used to train a model (e.g., a thermal prediction model) as described below. In one or more embodiments, a model may refer to an algorithm trained on data to identify patterns, make predictions, or perform tasks based on an input. In one or more embodiments, the training data may include relationships between the thermal state (i.e., temperature, heating/cooling rate, etc.) of a target hardware component (i.e., a hardware component whose thermal state the thermal prediction model aims to predict) and the thermal state of other hardware components of the edge device (e.g., 100 in FIG. 1) as discussed below in steps 304-310. In one or more embodiments, the thermal prediction model is a model that includes the functionality to predict the thermal state of the target hardware component using the thermal data from other hardware components, when the target hardware component's thermal data is unavailable.

In step 304, the training device (e.g., 102 in FIG. 1) splits the training data into a training set and a testing set. In one or more embodiments, the training set is the portion of the data used to train the thermal prediction model while the test set is the portion of the data used to test the model's accuracy. In a non-limiting example, if a model's purpose is to identify fruit, the test set will include images of fruits each labeled with the names of corresponding fruits, and the model will learn to identify the characteristics of each fruit. Further, the test set would include unseen images (i.e., images of the fruit that were not part of the training set) of the fruit which the model would attempt to classify to test the model's accuracy. In one or more embodiments, all of the hardware components are selected as features (i.e., the input variables used by a model to make predictions or decisions) while the target hardware component is selected as the target (i.e., the output the model aims to predict based on the features).

In step 306, the training device (e.g., 102 in FIG. 1) trains a thermal prediction model using the training set and the testing set. In one or more embodiments, the training device (e.g., 102 in FIG. 1) may also use feedback from previous thermal prediction models to train the thermal prediction model. In one or more embodiments, the thermal prediction model includes the functionality to predict the thermal state of the target hardware component using the thermal data from other hardware components, when the target hardware component's thermal data is unavailable. In one or more embodiments, the hardware components and the target hardware component reside on the same edge device (e.g., 100 in FIG. 1). In one or more embodiments, the thermal prediction model may utilize an RNN. In one or more embodiments, the RNN uses a long short-term memory (LSTM) layer. In one or more embodiments, an RNN is a neural network (i.e., a system that learns patterns from training data by utilizing a number of layers, neurons, weights, biases, activation functions, propagation function, etc., which are generally used to model how the human brain processes information) designed to process sequential data by maintaining a memory of previous inputs (e.g., thermal data of the target hardware component relative to the thermal data of the other hardware components). In one or more embodiments, LSTM refers to a specialized RNN that uses gates (i.e., decision-makers) to remember important data and forget unimportant data.

In one or more embodiments, RNNs may encounter a phenomenon called loss of gradient. In one or more embodiments, loss of gradient occurs in RNNs when the signals used to adjust the RNN become too strong or weak making it hard for the RNN to learn from data earlier in the sequence. In one or more embodiments, LSTMs reduce the loss of gradient issues by using a memory cell (i.e., a component used to store long-term data to be used by the LSTM RNN) and gates (e.g., forget gates, input gates, output gates, etc.) to control which data is kept, updated, or discarded allowing the RNN to retain important information over long sequences of inputs. In one or more embodiments, the forget gate determines which data to erase from the memory cell based on the current input and the hidden state (i.e., a short-term memory that carries information from previous steps to help process the current input and guide future predictions), the input gate determines which new data to add to the memory cell, and the output gate determines which data is sent to a hidden state to influence the next steps. It should be appreciated, that the LSTM will improve the thermal prediction model accuracy by retaining relevant historical thermal data while filtering out anomalous thermal data ensuring better predictions of the target hardware component's thermal state. In one or more embodiments, the LSTM RNN includes a dense layer as a final output layer. In one or more embodiments, the dense layer takes all the learned features (i.e., patterns or relationships the model has identified from the input data) from the LSTM RNN and makes a final prediction.

In a non-limiting example, if the training data indicates that whenever hardware components one and two are at 30° C., the target hardware component is around 25° C., the model identifies this as a correlation. In one or more embodiments, the thermal prediction model leverages this correlation and other correlations and patterns derived from the thermal behavior of the hardware components allowing the thermal prediction model to predict the thermal state of the target hardware components under a wide range of thermal conditions. It should be appreciated, that this will allow the edge device (e.g., 100 in FIG. 1) to operate efficiently and safely even when the target hardware component's thermal sensor data is unavailable. In one or more embodiments, the thermal prediction model includes the functionality to predict the thermal state of more than one target hardware component. In one or more embodiments, the thermal prediction model is updated when at least one of the hardware components receives an update. In one or more embodiments, the thermal prediction model is updated when a hardware component is added and/or removed from the edge device (e.g., 100 in FIG. 1).

In step 308, the training device (e.g., 102 in FIG. 1) determines whether the trained model is accurate. In one or more embodiments, the training device (e.g., 102 in FIG. 1) may use data from the testing set to determine if the model is accurate.

In a non-limiting example, the edge device (e.g., 100 in FIG. 1) includes hardware components one, two, and three and the target hardware component. The training device (e.g., 102 in FIG. 1) feeds the thermal prediction model the thermal data of hardware components one, two, and three as indicated above, and asks the thermal prediction model to predict the thermal state of the target hardware component. Finally, if the thermal prediction model's result is within a predetermined threshold (e.g., within 10% of the actual temperature) then the thermal prediction model will be deemed accurate. In one or more embodiments, the training device (e.g., 102 in FIG. 1) tests multiple pieces of data from the testing set and takes an average of the result before deeming the thermal prediction model accurate. In one or more embodiments, the predetermined threshold may be based on the sensitivity of the target hardware component (i.e., how sensitive the target hardware component is to high or low temperatures when operating). In one or more embodiments, the predetermined threshold may be determined by any means known in the art or discovered in the future.

In one or more embodiments, the training device (e.g., 102 in FIG. 1) uses a mean squared error (MSE) loss function to evaluate the accuracy of the model. In one or more embodiments, the MSE loss function evaluates the accuracy of the thermal prediction model by calculating the average square difference between the predicted and the actual values of the target hardware component's thermal state. It should be appreciated, that the MSE loss function is useful because it quantifies prediction accuracy by penalizing large errors more heavily resulting in a clear measure of the model's accuracy. In one or more embodiments, the training device (e.g., 102 in FIG. 1) may also utilize an adaptive moment estimation (ADAM) optimizer to adjust the thermal prediction model's parameters (i.e., weights and biases) by leveraging adaptive learning rates (i.e., adjusting the parameters of the model based on the gradients of loss from the MSE loss function) to improve the accuracy of the thermal prediction model. In one or more embodiments, the gradients of loss of the MSE loss function indicate how much each parameter needs to change to reduce the error in the prediction. In one or more embodiments, the gradients of loss of the MSE loss function are calculated by the ADAM optimizer with respect to the thermal prediction model parameters. In one or more embodiments, validation loss and training loss are calculated to assess and improve the accuracy of the thermal prediction model. In one or more embodiments, validation loss is a measure of how well the thermal prediction model's predictions matched the actual values of the testing set to evaluate the model's ability to generalize to unseen data and identify potential overfitting (i.e., being too attuned to the training data, including noise (i.e., standard randomness in the data) contained within the training data, and not able to adapt to other data sets, making it perform poorly on new unseen data). In one or more embodiments, the training loss is a measure of how well the model's prediction matches the actual values in the training set. In one or more embodiments, the training device (e.g., 102 in FIG. 1) may make the determination by any means known in the art or discovered in the future. Accordingly, if the result is YES then the method ends if the result is NO then the method proceeds to step 310.

In step 310, the training device (e.g., 102 in FIG. 1) sends feedback to the thermal prediction model. In one or more embodiments, the feedback indicates what was incorrect about the prediction (e.g., the predicted temperature of the target hardware component was too high or too low). In one or more embodiments, the method proceeds to step 306 and the training device (e.g., 102 in FIG. 1) uses the feedback to retrain the thermal prediction model. In one or more embodiments, steps 306-310 are repeated until the training device (e.g., 102 in FIG. 1) determines that the trained model is accurate.

In one or more embodiments, the method may end following step 308.

Embodiments of the disclosure may be implemented using computing devices. Turning to FIG. 4, FIG. 4 shows a diagram of a computing device (400) in accordance with one or more embodiments. The computing device (400) may include one or more computer processor(s) (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (408) (e.g., Bluetooth interface, infrared interface, network interface, optical interface, etc.), input devices (410), output devices (412), and numerous other elements (not shown) and functionalities. Each of these components is described below.

In one embodiment, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. The communication interface (408) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment, the computing device (400) may include one or more output devices (412), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (410, 412) may be locally or remotely connected to the computer processor(s) (402), non-persistent storage (404), and persistent storage (406). Many diverse types of computing devices exist, and the aforementioned input and output device(s) (410, 412) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments above, numerous specific details are set forth in order to provide a more thorough understanding of one or more embodiments. However, it will be apparent to one of ordinary skill in the art that the one or more embodiments may be practiced without these specific details. In other instances, well-known features have not been described in detail to avoid unnecessarily complicating the description.

In the prior description of the figures, any component described with regard to a figure, in various embodiments, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device (not shown), a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for deploying a thermal prediction model, the method comprising:
making a first determination, by a controller, that a target hardware component's thermal data is unavailable;
sending, in response to the first determination, a request to the thermal prediction model for a predicted thermal state of the target hardware component;
receiving, from the thermal prediction model, the predicted thermal state of the target hardware component; and
adjusting, using the controller and based on the predicted thermal state, thermal regulation of the target hardware component.

2. The method of claim 1, further comprising:
generating the thermal prediction model by:
identifying the target hardware component from a plurality of hardware components on an edge device;
receiving training data for the target hardware component from the edge device;
training, by a training device, using the training data, the thermal prediction model, wherein the thermal prediction model is configured to generate the predicted thermal state; and
making a second determination that the model is accurate.

3. The method of claim 1, further comprising:
generating the thermal prediction model by:
identifying the target hardware component from a plurality of hardware components on an edge device;
receiving training data for the target hardware component from the edge device;
training, by a training device, using the training data, the thermal prediction model, wherein the thermal prediction model is configured to generate the predicted thermal state; and
making a second determination that the model is not accurate; and
sending feedback, based on the second determination, to the training device.

4. The method of claim 2, wherein generating the thermal prediction model further comprises:
splitting, prior to training, the training data into a training set and a testing set, wherein training using the training data comprises training using the training set and evaluating using the testing set.

5. The method of claim 2, wherein the thermal prediction model is a recurrent neural network (RNN).

6. The method of claim 5, wherein the RNN uses long short-term memory.

7. The method of claim 1, wherein adjusting thermal regulation of the target hardware component comprises adjusting a speed of a fan or adjusting a flow rate of a liquid cooling device.

8. A non-transitory computer readable medium (CRM) comprising computer readable program code, which when executed by a computer processor, enables the computer to perform a method for deploying a thermal prediction model, the method comprising:
making a first determination, by a controller, that a target hardware component's thermal data is unavailable;
sending, in response to the first determination, a request to a thermal prediction model for a predicted thermal state of the target hardware component;
receive, from the thermal prediction model, the predicted thermal state of the target hardware component; and
adjusting, using the controller and based on the predicted thermal state, thermal regulation of the target hardware component.

9. The non-transitory CRM of claim 8, wherein the method further comprises:
generating the thermal prediction model by:
identifying the target hardware component from a plurality of hardware components on an edge device;
receiving training data for the target hardware component from the edge device;
training, by a training device, using the training data, the thermal prediction model, wherein the thermal prediction model is configured to generate the predicted thermal state; and
making a second determination that the model is accurate.

10. The non-transitory CRM of claim 8, wherein the method further comprises:
generating the thermal prediction model by:
identifying the target hardware component from a plurality of hardware components on an edge device;
receiving training data for the target hardware component from the edge device;
training, by a training device, using the training data, the thermal prediction model, wherein the thermal prediction model is configured to generate the predicted thermal state; and
making a second determination that the model is not accurate; and
sending feedback, based on the second determination, to the training device.

11. The non-transitory CRM of claim 9, wherein generating the thermal prediction model further comprises:
splitting, prior to training, the training data into a training set and a testing set, wherein training using the training data comprises training using the training set and evaluating using the testing set.

12. The non-transitory CRM of claim 9, wherein the thermal prediction model is a recurrent neural network (RNN).

13. The non-transitory CRM of claim 12, wherein the RNN uses long short-term memory.

14. The non-transitory CRM of claim 8, wherein adjusting thermal regulation of the target hardware component comprises adjusting a speed of a fan or adjusting a flow rate of a liquid cooling device.

15. The non-transitory CRM of claim 14 where adjusting thermal regulation of the target hardware component comprises adjusting a second thermal regulation of a second component of an edge device.

16. An edge device for deploying a thermal prediction model, the edge device comprising:
persistent storage; and
a processor, programmed to:
make a first determination, by a controller, that a target hardware component's thermal data is unavailable;
send, in response to the first determination, a request to a thermal prediction model for a predicted thermal state of the target hardware component;
receive, from the thermal prediction model, the predicted thermal state of the target hardware component; and
adjust, using the controller and based on the predicted thermal state, thermal regulation of the target hardware component.

17. The edge device of claim 16, wherein the processor is further programmed to:
generate the thermal prediction model by:
identifying the target hardware component from a plurality of hardware components on the edge device;
receiving training data for the target hardware component from the edge device;
training, by a training device, using the training data, the thermal prediction model, wherein the thermal prediction model is configured to generate the predicted thermal state; and
making a second determination that the model is accurate.

18. The edge device of claim 16, wherein the processor is further programmed to:
generate the thermal prediction model by:
identifying the target hardware component from a plurality of hardware components on the edge device;
receiving training data for the target hardware component from the edge device;
training, by a training device, using the training data, the thermal prediction model, wherein the thermal prediction model is configured to generate the predicted thermal state;
making a second determination that the model is not accurate; and
sending feedback, based on the second determination, to the training device.

19. The edge device of claim 17, wherein generating the thermal prediction model further comprises:
splitting, prior to training, the training data into a training set and a testing set, wherein training using the training data comprises training using the training set and evaluating using the testing set.

20. The edge device of claim 17, wherein the thermal prediction model is a recurrent neural network (RNN).
